(19) United States
(12) Patent Application Publication
(10) Pub. No.: US 2003/0233405 A1
(43) Pub. Date: Dec. 18, 2003

(54) Method and apparatus for manipulating data of a disc media

(75) Inventors: Crasher Guo, Gansu province (CN); Richard Hsieh, Chongqing City (CN)

Correspondence Address: HOGAN & HARTSON L.L.P., 500 S. GRAND AVENUE, SUITE 1900, LOS ANGELES, CA, 90071-2611, US

(73) Assignee: FARSTONE TECH, INC.

(21) Appl. No.: 10/313,093

(22) Filed: Dec. 5, 2002

(30) Foreign Application Priority Data
Jun. 17, 2002 (TW) 91113120

(51) Int. Cl. G06F 15/16

(52) U.S. Cl. 709/203

(57) ABSTRACT

A server system that integrates jukebox emulation technique and network storage technique. According to the invention, a CD-ROM server is emulated to create, store and access virtual CD-ROMs across any TCP/IP network. Users can run CD-ROMs from the server system without the actual CD-ROMs. Image files can be mounted by the administrator or from remote client terminals.

A server system that integrates jukebox emulation technique and network storage technique. According to the invention, a CD-ROM server is emulated to create, store and access virtual CD-ROMs across any TCP/IP network. Users can run CD-ROMs from the server system without the actual CD-ROMs. Image files can be mounted by the administrator or from remote client terminals.

### BACKGROUND OF THE INVENTION

1. Field of the Invention

The present invention relates generally to a method and apparatus for accessing data of a disc media, and more particularly to a network multimedia system that can mount CD data at client side to access every type of CD without the actual CD-ROMs.

2. Description of Prior Art

Conventional emulated jukebox loads emulated CD files at server side. The emulated CD files therein are typically accessed by users through Web “browsers” (e.g., Microsoft Internet Explorer.TM. or Netscape Navigator.TM. browser software) or other “Internet applications”. The conventional emulated jukebox, such as the Disc Zerver system, adopts a single-side Mounted technique, and workload at server side is too heavy. It costs greatly to increase the amount of emulated CD files.

FIG. 1 (Prior Art) is a schematic block diagram of the conventional Disc Zerver system. As shown in FIG. 1, the Disc Zerver system comprises client side 1 and server side 3. Client side 1 has a plurality of sub-client sides 11-1m connected through network 119. Application programs 111 in sub-client side 11 create emulated CD files 37, based upon disc data 113 or hard disk (H.D.) data 115. Management programs 31 in server side 3 create emulated CD files 37, based upon disc data 33 that is stored in CD-ROM. Such emulated CD files 37 can be stored in data storage 35 of server side 3 via management programs 31.

Typically, during Disc Zerver system start up, all the emulated CD files 37 are loaded into emulated file system of server side 3 through driver at server side 3. Afterwards, tree node in emulated file system is created. Users can access emulated CD files 37 located in server side 3 simultaneously through browser 117 for the purposes of resource sharing over network.

The conventional emulated jukebox is analogous to a file server. The emulated CD files can be accessible to emulate actual CD-ROM at server side. However, the conventional emulated jukebox is unable to directly support executable files in CD's, unless a client-side browser plug-in is provided. On the other hand, owing to the server side using centralized mount operation, all the emulated CD files have to be loaded at server side during system start up. Therefore, hardware cost for the conventional emulated jukebox is extremely high.

FIG. 2 (Prior Art) depicts a flow chart of the loading operation at the server side of the conventional Disc Zerver system. The operation begins in step S23 with the conventional Disc Zerver system emulating a CD-ROM drive after the conventional Disc Zerver system start up. Then, in step S25 the server side creates a CD file comprising data in the CD-ROM. Next, in step S27, the CD file is loaded into the emulated file system at the server side. Finally, in step S29, a tree node is generated and the loading operation is complete.

The conventional emulated jukebox is not capable of loading CD files directly into the client side. The conventional emulated jukebox can only load such CD files stored in the server side into such server side. And the conventional emulated jukebox can provide the user with limited CD formats support. Moreover, the CD files are loaded into the server side as a whole. Which CD files are going to be loaded at the conventional emulated jukebox is not selected based on the needs of the users. The users cannot make choice of loaded CD files.

### SUMMARY OF THE INVENTION

The present invention provides a server system and method regarding the same to resolve the foregoing problems faced by the conventional emulated jukebox. The present invention has the advantage of providing an inexpensive alternative to CD-ROM towers and/or jukeboxes. No need to insert the physical CD-ROM into a drive in order to run applications. Moreover, the present invention lightens the load of server system.

An object of the present invention is to provide a network multimedia system, that integrates jukebox emulation technique and network storage technique. The network multimedia system can create and store CD's that can be simultaneously accessed by multiple users across the Internet and/or Intranet. Image files can be mounted by the administrator or from remote client terminals.

Another object of the present invention is to provide a network multimedia system with a compatible ISO9660 file system, which can Support most CD formats, such as CD-ROMs, Audio CD's, Mixed-Mode CD's, Photo CD's, Video CD's or DVD-ROMs, etc. Moreover, the network multimedia system can support up to 1000 CD jukeboxes, and each jukebox can hold unlimited CD-ROMs.

A further object of the present invention is to provide a network multimedia system and method for rapid searching image files, which can automatically create an index file in accordance with a file catalog. Finding CD-ROMs' is no longer a problem by means of index file at the server side for searching image files. Moreover, according to the present invention, the CD-ROM performance is optimized.

In accordance with an aspect of the present invention, a network multimedia system can support any discs of any types without the use of any CD-ROM. The network multimedia system has a server side and a client side. The network multimedia system comprises a storage device and a processor. The storage device is attached to the network for storing an operating system. The processor is coupled to the storage device for creating an image file for the disc data and accessing the image file already stored in the storage device. The number of the predetermined files is plural. The image file simulates at least one jukebox. The processor mounts the image file at the server side and emulates the CD-ROM at the client side in respect of the image file.

In the preferred embodiment of the invention, the number of the image files is plural. The image file simulates at least one jukebox corresponding to one entry. The entry corresponds to a CD-ROM.

In the preferred embodiment of the invention, the storage device is located in the server side. The storage device includes a hard disk. The storage device stores an index file. The index file is created in accordance with a file catalog. The storage device further includes an embedded device.

In the preferred embodiment of the invention, the processor further includes a generating device. The generating device is located within the client side.

In the preferred embodiment of the invention, the generating device generates at least one simulating module for emulating the image files. The generating device further generates an adapting unit. The adapting unit simulates a SCSI adapter. The simulating module is emulated on the adapting unit.

In the preferred embodiment of the invention, the processor further includes a mounting/rejecting module. The mounting/rejecting module accesses the image files stored in the storage device. The mounting/rejecting module mounts the image files into the simulating module. The simulating module has data contained in the image files. The mounting/rejecting module rejects the image files from the selected simulating module.

In the preferred embodiment of the invention, the image files are created at the server side and the client side, in order to play CD's at hard drive speed, giving optimal CD Tower and network performance. The server side can mount image files and the client side can mount as well.

The present invention may best be understood through the following description with reference to the accompanying drawings, in which:

### BRIEF DESCRIPTION OF THE DRAWING

FIG. 1 (Prior Art) is a schematic block diagram of the conventional Disc Zerver system.

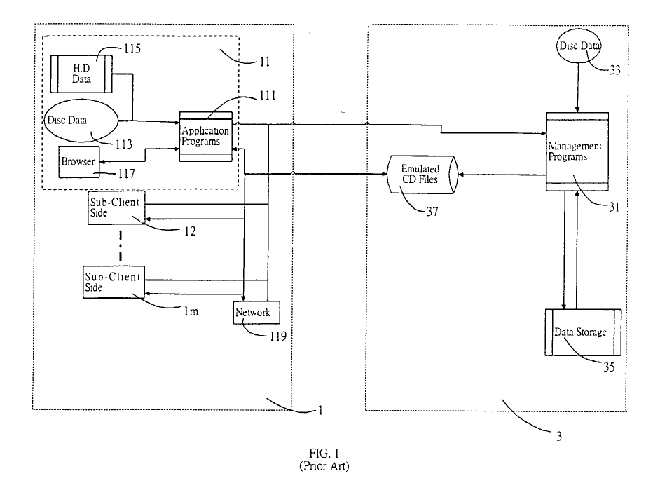

FIG. 2 (Prior Art) illustrates a flow chart of the loading operation at server side of the conventional Disc Zerver system.

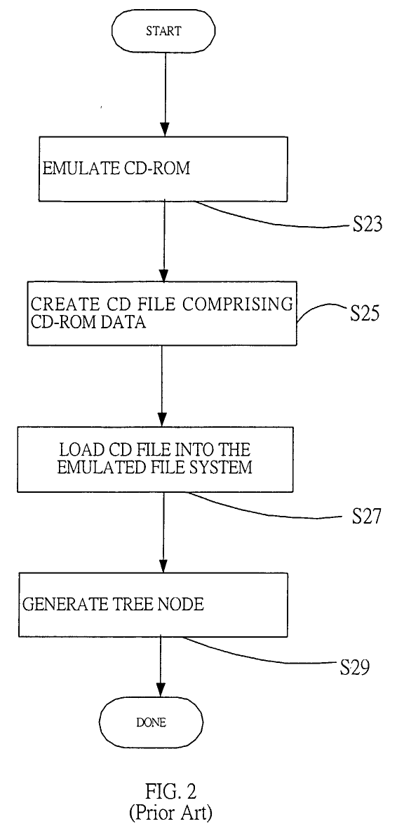

FIG. 3 is a schematic block diagram of the network multimedia system of a preferred embodiment according to the present invention.

FIG. 4 graphically represents the mounting operation at client side of a preferred embodiment according to the present invention.

FIG. 5 illustrates a flow chart of the implementation at server side of a preferred embodiment according to the present invention.

FIG. 6 illustrates a flow chart of the pressing operation at client side of a preferred embodiment according to the present invention.

FIG. 7 illustrates a flow chart of the mounting operation at client side of a preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new CD manipulation technique for a network multimedia system to mount CD image files at both server side and client side, which can improve the performance of the conventional emulated jukebox.

According to the preferred embodiment of the present invention, a network multimedia system can support any discs of any types without the use of any CD-ROM. The network multimedia system has a server side and a client side. The network multimedia system comprises a storage device and a processor. The storage device is attached to the network for storing an operating system. The processor is coupled to the storage device for creating an image file for the disc data and accessing the image file already stored in the storage device. The processor mounts the image file at the server side and emulates the CD-ROM at the client side in respect of the image file.

The number of the image files is plural. The image file simulates at least one jukebox corresponding to one entry. The entry corresponds to a CD-ROM.

The storage device is located in the server side. The storage device includes a hard disk. The storage device stores an index file. The index file is created in accordance with a file catalog. The storage device further includes an embedded device.

The processor further includes a generating device. The generating device is located within the client side.

The generating device generates at least one simulating module for emulating the image files. The generating device further generates an adapting unit. The adapting unit simulates a SCSI adapter. The simulating module is emulated on the adapting unit.

The processor further includes a mounting/rejecting module. The mounting/rejecting module accesses the image files stored in the storage device. The mounting/rejecting module mounts the image files into the simulating module. The simulating module has data contained in the image files. The mounting/rejecting module rejects the image files from the selected simulating module.

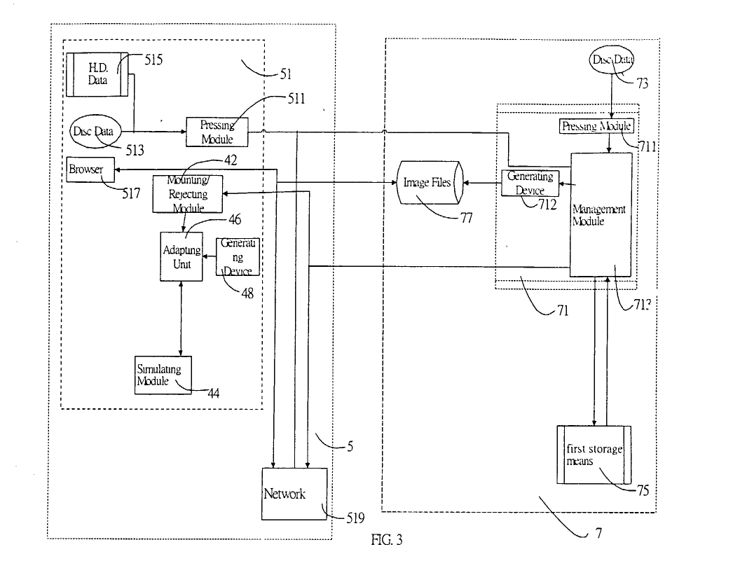

Referring to FIG. 3, a schematic block diagram of the network multimedia system of a preferred embodiment according to the present invention is shown. The network multimedia system of the present invention can support any discs of any types without the use of any CD-ROM to share data through network. The network multimedia system may interconnect over Internet and/ or Intranet. The network multimedia system has a server side 7 and a client side 5. The network multimedia system comprises a storage device and a processor. The storage device having a first storage means 75 and a second storage means 71 is located in the server side. The processor is located in the server side 7 and the client side 5.

As shown in FIG. 3, the client side 5 of the network multimedia system may have a plurality of sub-client sides 51 connected through network 519. Application programs are executed at client side 5 to control a processor. The processor of the client side 5 comprises a pressing module 511 to press disc data 513 or hard disk (H.D.) data 515 into virtual CD-ROM image files 77. The virtual CD-ROM image files 77 can be stored in the first storage means 75, such as a hard disk, of the server side 7. The client side 5 may include a plurality of browsers 5171-517 [symbol] to access the image files 77 mounted in the server side 7 over Internet simultaneously. The present invention can be accessed through an Internet browser, through Windows®) Explore, or directly from the Client Windows® based application.

The processor also comprises a generating device 48. The generating device 48 generates an adapting unit 46 to simulate a SCSI adapter. On the adapting unit 46, at least one simulating module 44 is emulated. Each simulating module 44 can create a plurality of virtual CD drives to emulate physical CD-ROM drives and can build virtual image files of CD's. Each simulating module 44 can emulate the image file 77 into at least one jukebox. The processor further comprises a mounting/rejecting module 42 to access the image files 77 stored in the first storage means 75.

The mounting/rejecting module 42 can mount a single or a plurality of virtual image files 77 in the first storage means 75 of server side 7 to the simulating module 44 simultaneously and directly through the adapting unit 46, so as to play virtual CD as if an actual CD drive is used.

As shown in FIG. 3, the storage device is located in the server side 7 of the network multimedia system. The storage device is attached to the network for storing an operating system. Connected with operating system is network protocol stack, which may be TCP/IP, Net Bios or the like, as is well understood in the art. Network protocol stack is interconnected to network device driver which operates with network hardware adapter. The first storage means 75 and the second storage means 71 disclosed herein may be provided via a wide-variety of other computer readable storage media including a disk or a program memory. The second storage means 71 shown in FIG. 3 is preferably implemented in firmware, such as an embedded device. However, such storage means may also be implemented in software or hardware. System programs can be stored in the second storage means 71, and image files 77 can be stored in the first storage means 75. Hence, the system programs and the image files are kept separately. The processor of the server side 7 is included in the second storage means 71. The processor comprises a pressing module 711, a generating device 712 and a management module 713. The management module 713 executes a management program. The pressing module 711 press disc data 73 into virtual CD-ROM image files 77. The virtual CD-ROM image files 77 can be stored in the first storage means 75 of the server side 7. The image files 77 stored in the first storage means 75 of the server side 7 can be mounted in the virtual file system of the server side 7 selectively through the generating device 712, in order to create a tree node and emulate the CD-ROM at the client side 5 over the Internet.

The image files 77 can be accessed at client side 5 simultaneously by browsing with the browsers 517. The access operation can be executed in a cache memory, thereby increasing performance with 200x disk drive speed. The need to physically mount CD-ROMs' into a drive, in order to run CD applications is eliminated.

During the image files 77 are created, a file catalog is read out. Moreover, an index file used for file searching is created in response to the file catalog. The index file can be stored in the first storage means 75. The present invention organizes CD's and manages all CD's for ease to find and use.

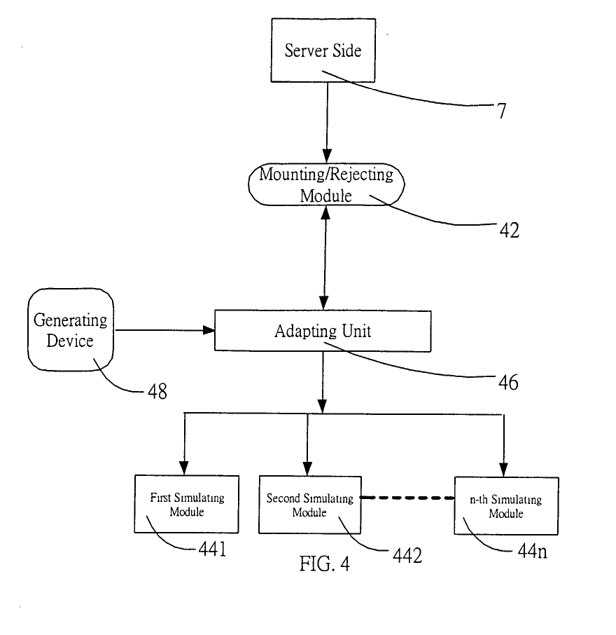

FIG. 4 graphically represents the mounting operation at client side of a preferred embodiment according to the present invention. As shown in FIG. 4, the generating device 48 generates an adapting unit 46 to simulate a SCSI adapter. On the adapting unit, at least one simulating module 44 is emulated. Each simulating module can emulate physical CD-ROM drive. The operating system (OS) examines the number of the simulating modules 44 on the adapting unit 46, and if the image files 77 is existed in such simulating modules 44. After the contents of the image files 77 in the simulating modules 44 are read, the adapting unit 46 can be removed.

The mounting/rejecting module 42 of the processor of the client side 5 displays file list of the image files 77 stored in the first storage means 75 of the server side 7 to the user. The mounting/rejecting module 42 mounts the image files 77 selected by the users into the user-designated simulating modules 44 with mounting programs. The simulating module 44 has data contained in the image files 77. The users can access the image files 77 directly. In case the users don't need to access the image files 77, the mounting/rejecting module 42 rejects such image files 77 from the selected simulating modules 44.

The simulating module 44 can also be generated in some other ways. The image files 77 selected by the users can be mounted directly into the user-designated simulating modules 44 by way of the mounting/rejecting module 42 without the adapting unit 46.

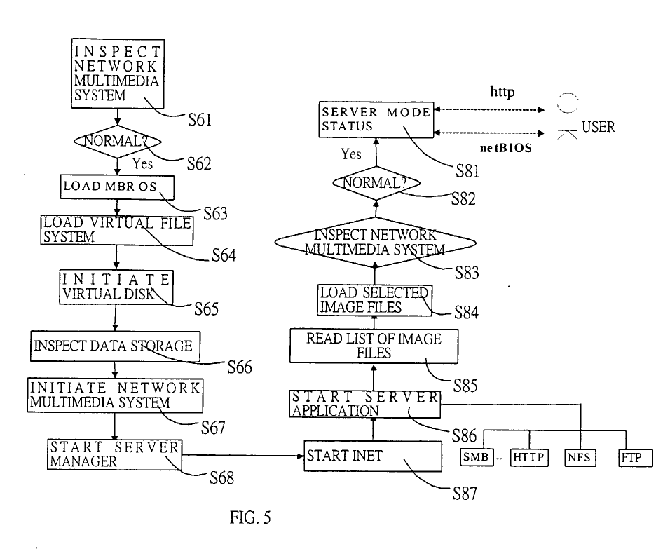

FIG. 5 illustrates a flow chart of the implementation at server side of a preferred embodiment according to the present invention. Administrator programs, INET administrator program and utility program can be executed at the server side. The utility program comprises SMB server program, NFS server program, HTTP server program, and FTP server program.

As shown in FIG. 5, the operation at the server side begins in step S61 with the network multimedia system is inspected. Then, in step S62, determine if the network multimedia system is normal or not. Next, in step S63, a MBR (Master boot record) OS is loaded into the second storage means 71 at the server side. Then, in step S64, a virtual file system is loaded at the server side. Next, in step S65, a virtual disk is initiated. The virtual disk can be emulated by means of memory. The compression storage library may be used to economize on storage space occupied in the second storage means 71. Then, in step S66, the data storage 35 is inspected. Next, in step S67, the network multimedia system is initiated. Then, in step S68, the network multimedia system starts server manager. Next, in step S87, the server manager starts INET server program to provide TCP/IP service. Then, in step S86, the server manager starts server application, such as SMB server program, NFS server program, HTTP server program, FTP server program.

The SMB protocol can support other platforms with file system services. The NFS server program provides NFS file system services. The HTTP server program provides Hypertext transport protocol services through Web server. The FTP server program provides file transfer protocol service for downloading and uploading files.

Then, in step S85, the list of image files is read. Next, in step S84, the selected image files are mounted. Then, in step S83, the network multimedia system is inspected. In step S82, determine if the network multimedia system is normal. Next, in step S81, the status comes to server mode status.

According to the preferred embodiment of the present invention, the image files stored in the server side can be mounted into the simulating module of the client side, in order to access such image files at the client side through browser environment.

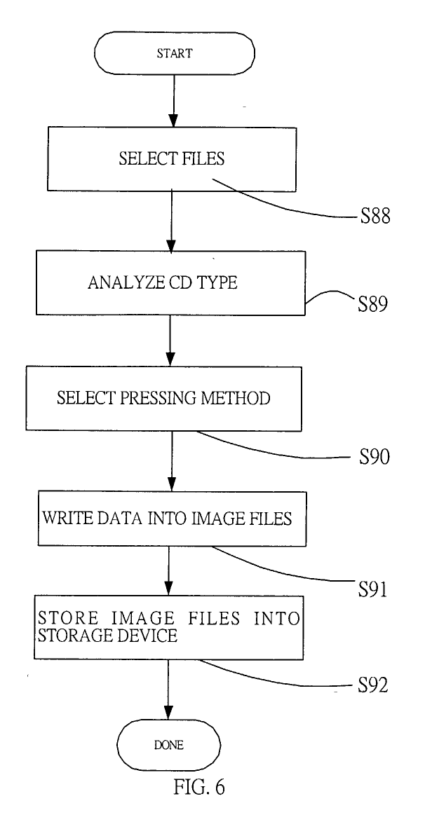

FIG. 6 illustrates the operating flow chart of the client side as per an embodiment of the invention, wherein the image files are created. As shown in FIG. 6, the operation at the client side customizes file CD. Step S88 is to select files to be created. In this step, the client side customize file CD with selected files in hard disk (H.D.) or compact disc (CD). Step S89 is to analyze CD type at the processor of the client side. Then, in step S90 the processor of the client side selects pressing method. The user may select to copy used data area or all information within each sector to the image files. Next, in step S91, data are written into image files. Finally, in step S92, image files are stored into data storage.

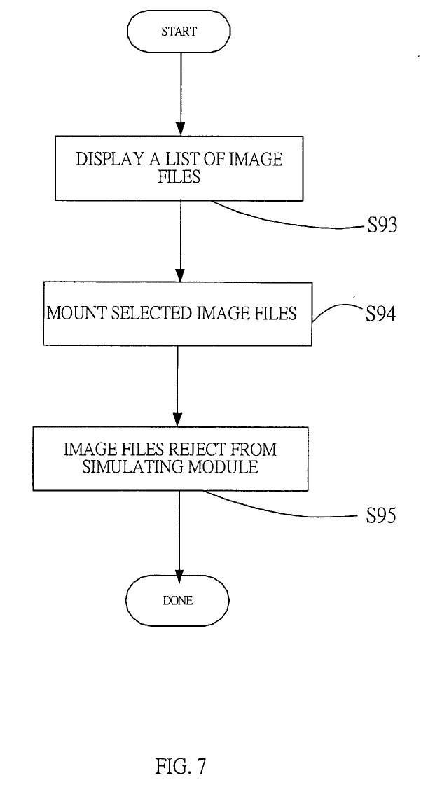

The present invention can enhance multimedia capability. Multiple CD-ROM applications may be run simultaneously. No need to exchange CD-ROMs. FIG. 7 illustrates a flow chart of the mounting operation at client side of a preferred embodiment according to the present invention, wherein at least one image file can be mounted into at least one simulating module directly at the same time. At least one simulating module is available at each client side. As shown in FIG. 7, step S93 is to display a list of image files. Then, in step S94 the mounting/rejecting module mounts user-selected image files into user-designated simulating module. Next, in step S95, the used image files can be rejected from simulating module.

The present invention creates and plays customized CD's with MP3 compression to economize space, customize VCD from original CD's ROMs by removing demo files or other unnecessary files from the CD-ROM as well. The present invention allows conversion from and to ISO 9660 format. The present invention can also analyze and display CD's and CD drive properties.

The present invention is ideal for schools, training centers, libraries, corporate environments, or any situation where multiple users need to access a single CD-ROM at the same time. Also is ideal for situations where CD-ROM information needs to be accessed by multiple users quickly and conveniently over the LAN or Internet.

The present invention has network capability to create a wide-variety of CD's on a file server, allowing CD resources to be shared across a network. The present invention provides embedded network services. Administrator can control HTTP, SMB, DHCP, NCP, FTP and NFS services. The system programs and the image files are kept separately. Accordingly, the present invention has the advantage of providing a long utility period and a high reliability.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A network multimedia system for supporting any discs of any types without the use of any CD-ROM, said network multimedia system having a server side and a client side, said network multimedia system comprising:
a storage device attached to said network for storing an operating system; and
a processor coupled to said storage device for creating a predetermined file for said disc data and accessing said predetermined file stored in said storage device,
wherein said processor mounts said predetermined file at said server side and emulates said CD-ROM at said client side in respect of said predetermined file.

2. The network multimedia system according to claim 1, wherein said storage device is located in said server side.

3. The network multimedia system according to claim 1, wherein said storage device includes a hard disk.

4. The network multimedia system according to claim 1, wherein the number of said predetermined files is plural.

5. The network multimedia system according to claim 1, wherein said storage device includes an embedded device.

6. The network multimedia system according to claim 1, wherein said processor further includes a generating device.

7. The network multimedia system according to claim 6, wherein said generating device generates at least one simulating module for emulating said predetermined files.

8. The network multimedia system according to claim 7, wherein said processor further includes a mounting/rejecting module.

9. The network multimedia system according to claim 8, wherein said mounting/rejecting module accesses said predetermined files stored in said storage device.

10. The network multimedia system according to claim 8, wherein said mounting/rejecting module mounts said predetermined files into said simulating module.

11. The network multimedia system according to claim 10, wherein said simulating module has data contained in said predetermined files.

12. The network multimedia system according to claim 11, wherein said mounting/rejecting module rejects said predetermined files from said selected simulating module.

13. The network multimedia system according to claim 6, wherein said generating device is located within said client side.

14. The network multimedia system according to claim 7, wherein said generating device further generates an adapting unit.

15. The network multimedia system according to claim 14, wherein said adapting unit simulates a SCSI adapter.

16. The network multimedia system according to claim 14, wherein said simulating module is emulated on said adapting unit.

17. The network multimedia system according to claim 1, wherein said storage device stores an index file.

18. The network multimedia system according to claim 17, wherein said index file is created in accordance with a file catalog.

19. The network multimedia system according to claim 1, wherein said predetermined file simulates at least one jukebox.
